(19) United States
(12) Patent Application Publication
(10) Pub. No.: US 2025/0244460 A1
(43) Pub. Date: Jul. 31, 2025

(54) DETECTION DEVICE, DETECTION SYSTEM, AND STORAGE MEDIUM

(71) Applicant: KABUSHIKI KAISHA TOSHIBA, Tokyo (JP)

(72) Inventors: Daiki YODA, Yokohama Kanagawa (JP); Hiroki MORI, Kawasaki Kanagawa (JP)

(73) Assignee: KABUSHIKI KAISHA TOSHIBA, Tokyo (JP)

(21) Appl. No.: 19/034,192

(22) Filed: Jan. 22, 2025

(30) Foreign Application Priority Data
Jan. 25, 2024 (JP) 2024-009542

(51) Int. Cl. G01S 13/32; G01S 7/35

(52) U.S. Cl. CPC G01S 13/32; G01S 7/356

(57) ABSTRACT

According to one embodiment, a detection device includes a first radar unit, a second radar unit, a data processing unit, and a determination unit. The first radar unit transmits radar signals. The second radar unit receives radar signals. The data processing unit processes radar information acquired by the second radar unit and outputs a first value and a first distance. The first value indicates a relationship between a signal strength. The first distance is determined by a distance between the first radar unit and the second radar unit. The determination unit determines that a target object exists at a position between the first radar unit and the second radar unit when the first value output from the data processing unit is smaller than or equal to a threshold value.

### CROSS-REFERENCE TO RELATED APPLICATIONS

This application is based upon and claims the benefit of priority from Japanese Patent Application No. 2024-009542, filed Jan. 25, 2024, the entire contents of which are incorporated herein by reference.

### FIELD

Embodiments described herein relate generally to a detection device, a detection system, and a storage medium.

### BACKGROUND

Systems configured to receive direct line-of-sight pulses and pulses reflected from a target person using a plurality of radar transceivers (UWB: Ultra Wide Band), which obtain time delay between the flight time of the direct line-of-sight signal and the flight time of the reflected signal from the channel impulse response (CIR) data obtained from both the two pulses to specify and track a position of the target person, have been proposed.

In the system of JP 2022-536216 A, the CIR obtained from both the line-of-sight signal and the reflected signal of the target object needs to be analyzed using processing of a comparatively large amount of computation in order to specify the position of the target person.

### BRIEF DESCRIPTION OF THE DRAWINGS

FIG. 1 is a view showing a configuration example of a detection system according to a first embodiment.

FIG. 2 is a view showing an example of application of the detection device according to the first embodiment.

FIG. 3 is a view showing an example of a configuration of the detection device according to the first embodiment.

FIG. 4 is a view showing an example of radar information after range FFT processing.

FIG. 5 is a flowchart showing an example of a processing flow of the detection system according to the first embodiment.

FIG. 6 is a view showing an example of a configuration example of a detection device according to a second embodiment.

FIG. 7 is a view showing an example of a waveform of an FMCW signal.

FIG. 8 is a view showing an example of a received signal.

FIG. 9 is a view showing an example of a reflection intensity distribution.

FIG. 10 is a flowchart showing an example of a processing flow of the detection system according to the second embodiment.

FIG. 11 is a view showing an example of a configuration of a detection device according to a third embodiment.

FIG. 12 is a view showing an example of a configuration of a detection device according to a fourth embodiment.

FIG. 13 is a view showing an example of a configuration of a detection device according to a fifth embodiment.

FIG. 14 is a view showing an example of a configuration of a detection device according to a sixth embodiment.

### DETAILED DESCRIPTION

In general, according to one embodiment, the detection device includes a first radar unit, a second radar unit, a data processing unit, and a determination unit. The first radar unit transmits radar signals. The second radar unit receives radar signals. The data processing unit processes radar information acquired by the second radar unit and outputs a first value and a first distance. The first value indicates a relationship between a signal strength. The first distance is determined by a distance between the first radar unit and the second radar unit. The determination unit determines that a target object exists at a position between the first radar unit and the second radar unit when the first value output from the data processing unit is smaller than or equal to a threshold value.

Embodiments will be described hereinafter with reference to the accompanying drawings. The following explanations disclose examples of devices and methods to embody the technical idea of the embodiments, and the technical idea of the embodiments is not limited by the structures, shapes, arrangements, materials, and the like of the constituent elements described below. Modification which is easily conceivable by a person of ordinary skill in the art comes within the scope of the disclosure as a matter of course. In order to make the description clearer, in the drawings, the size, thickness, planar dimensions or shape, etc., of each element may be schematically shown by changing from the actual implementation. In a plurality of drawings, elements with different dimensions or ratios may be included. In a plurality of drawings, corresponding elements may be denoted by the same reference numbers to omit repeated descriptions. Several elements may be assigned a plurality of names, but the names are mere examples and the elements may be assigned the other names. In addition, elements which are not assigned a plurality of names may be assigned the other names. Incidentally, in the following descriptions, “connection” may imply not only direct connections, but also connections via other elements.

### First Embodiment

First, a first embodiment will be described.

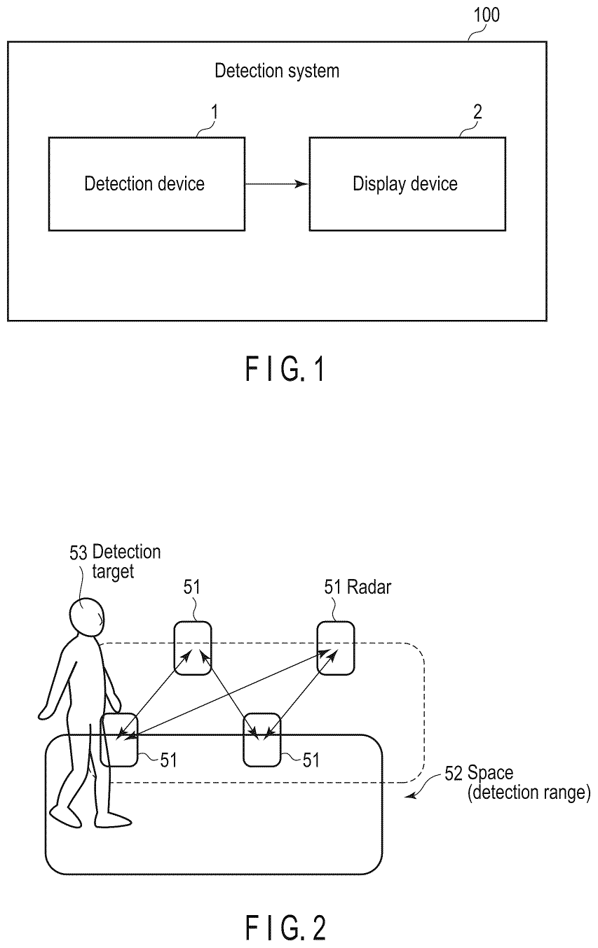

FIG. 1 is a view showing an example of a configuration of a detection system 100 according to a first embodiment.

The detection system 100 includes a detection device 1 and a display device 2. The detection device 1 and the display device 2 are connected by a wired or wireless connection.

The detection device 1 detects whether or not a detection target exists in a detection range. If the detection target exists in the detection range, the detection device 1 can also specify the position of the detection target. The detection device 1 of the first embodiment is provided with a unique method that can significantly reduce the amount of calculation required to specify the position of the detection target as compared to conventional methods. Details of the unique method with which the detection device 1 is provided will be described later.

The display device 2 displays detection results of the detection device 1. The display device 2 of the first embodiment, for example, displays detection or no detection of the detection target, the position of the detection target, and the like.

FIG. 2 is a view showing an example of application of the detection device 1. In this example, as shown in FIG. 2, a situation in which a detection target 53 enters and exits a space (detection range) 52 where a plurality of radars 51 are arranged is assumed. Each radar 51 operates synchronously under the control of a synchronization unit 13 to be described below, and the other radars 51 can receive radar signals transmitted from a certain radar 51. Incidentally, each radar 51 may autonomously transmit radar signals and acquire radar information at predetermined timing without the control of the synchronization unit 13 to be described below.

Normally, a radar obtains information such as the position, size and material of an object by analyzing a backscattered signal from the target. There are various existing methods for this analysis and, for example, it is possible to analyze from which direction the backscattered signal of the object arrives by executing an arrival direction estimation process.

If the position of the target is completely unknown, however, the analysis range needs to be sufficiently widened, and the amount of calculation becomes comparatively large. In contrast, if the position of the target can be specified to a certain extent, the amount of calculation can be reduced by analyzing only the assumed range.

With this background, the detection device 1 of the first embodiment is provided with a unique method for the purpose of simply specifying the position of the target. Double-ended arrows of solid lines in FIG. 2 indicate connection between different radars 51 in straight lines. As described above, since radars can obtain various information by using backscattered signals from the target, signals which are not backscattered from the target and which are made directly incident from one radar to another have hardly been used conventionally.

Incidentally, if a situation in which the radars 51 are arranged as shown in FIG. 2 and the detection target 53 is to pass through the space (detection range) 52 is assumed, and when the detection target 53 exists between two radars 51, the line of sight between the two radars 51 is blocked. For this reason, the signal power is significantly reduced as compared to a case where the detection target 53 does not exist. Therefore, the detection device 1 of the first embodiment detects the presence of the detection target 53 which exists between two radars 51 by using the information.

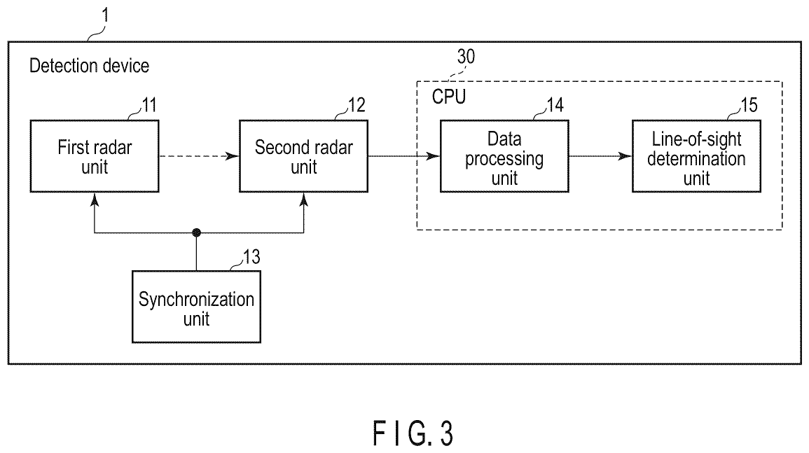

FIG. 3 is a view showing an example of a configuration of the detection device 1 according to the first embodiment.

The detection device 1 of the first embodiment includes a first radar unit 11, a second radar unit 12, a synchronization unit 13, a data processing unit 14, and a line-of-sight determination unit 15. For example, the data processing unit 14 and the line-of-sight determination unit 15 are realized by the CPU 30 running the programs. Alternatively, the data processing unit 14 and the line-of-sight determination unit 15 may be realized by hardware such as an electric circuit. Incidentally, arrows of solid lines indicate the flow of electric signals, and arrows of dashed lines indicate the flow of radar signals.

The first radar unit 11 is a device which transmits radar signals. The first radar unit 11 is, for example, a frequency modulated continuous wave (FMCW) radar. The first radar unit 11 is, for example, a radar 51 which is selected sequentially and cyclically one by one at predetermined intervals by the synchronizing unit 13 and which is selected at a certain time, among the plurality of radars 51 shown in FIG. 2. In addition, the first radar unit 11 can receive radar signals transmitted by itself, which are reflected by the detection target 53, in the same manner as a general use of radar.

The second radar unit 12 is a device which receives radar signals. The second radar unit 12 is, for example, an FMCW radar. The second radar unit 12 is, for example, a radar 51 other than the radar 51 selected as the first radar unit 11 by the synchronizing unit 13, among the plurality of radars 51 shown in FIG. 2. The radar signals from the radar 51 selected as the first radar 11 can be received by all other radars 51. The radar signals received by these radars can include signals blocked and attenuated by the target 53 and signals reflected on the target 53.

For example, the radar 51 applied as the second radar unit 12 is selected one by one at predetermined intervals by the synchronization unit 13, from among all or some of the other radars 51 during a period when a certain radar 51 is selected as the first radar unit 11.

The synchronization unit 13 is a device for coordinating the operations of the first radar unit 11 and the second radar unit 12. More specifically, the synchronization unit 13 notifies the first radar unit 11 of the timing to transmit the radar signals, and notifies the second radar unit 12 of the timing to acquire the radar information. As described above, when each radar 51 operates autonomously, the synchronization unit 13 is unnecessary.

For example, as shown in FIG. 2, when a plurality of radars 51 that can be selected as the first radar unit 11 or the second radar unit 12 are arranged in the detection range 52, the synchronization unit 13 can set a combination of the radar 51 to be applied as the first radar unit 11 and the radar 51 to be applied as the second radar unit 12, in accordance with a predetermined rule or arbitrarily.

The data processing unit 14 is a device which processes the radar information acquired by the second radar unit 12 when the radar signal is transmitted by the first radar unit 11. For example, the data processing unit 14 executes a fast Fourier transform (FFT) processing (range FFT processing) on the radar information and calculates the signal strength of the radar signal corresponding to the distance between the first radar unit 11 and the second radar unit 12.

The line-of-sight determination unit 15 determines whether the first radar unit 11 and the second radar unit are in a line-of-sight (LOS) state where the units can see each other directly or in a non-line-of-sight (NLOS) state where the units cannot see each other directly, based on the signal strength calculated by the data processing unit 14. In other words, the line-of-sight determination unit 15 determines whether or not the detection target 53 exists between the first radar unit 11 and the second radar unit.

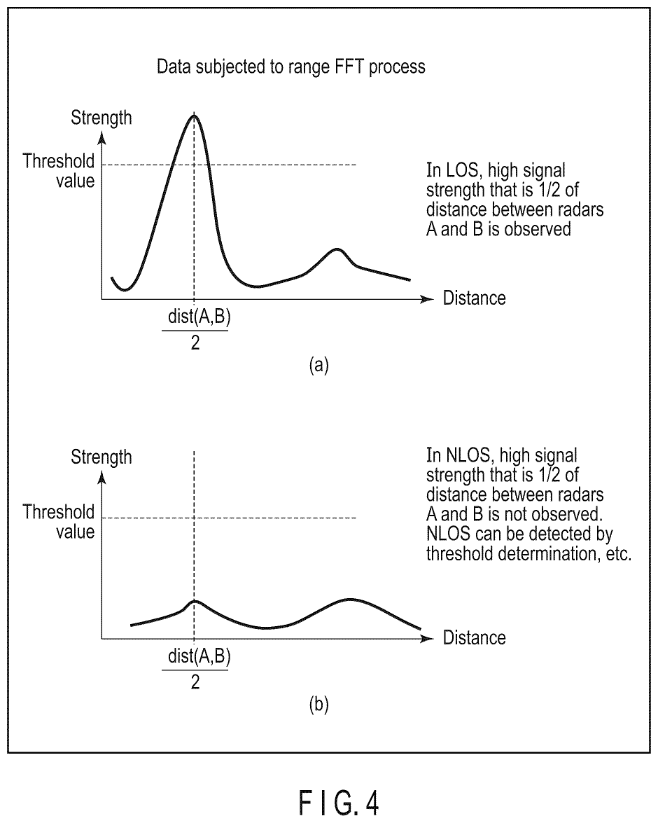

An example of a method of determining whether or not the detection target 53 exists between the first radar unit 11 and the second radar unit by the line-of-sight determination unit 15 will be described with reference to FIG. 4.

In the case of an FMCW radar, it is possible to classify the distance to a reflector by executing the range FFT processing on the acquired radar information.

FIG. 4 is a view showing an example of the radar information after the range FFT processing. A graph in FIG. 4(a) shows the data subjected

to the range FFT processing when the target does not exist between the radar A and the radar B.

In this case, a signal strength at a point corresponding to half the distance (dist(A,B)) between the radar A and the radar B is very high.

In contrast, a lower graph shows a case where the target exists between the radars, and it can be confirmed that the signal strength corresponding to the part corresponding to dist(A,B)/2 is very low as compared to the LOS state.

Based on the above, as shown in FIG. 4, it is possible to easily realize the determination of LOS/NLOS by setting an appropriate threshold value.

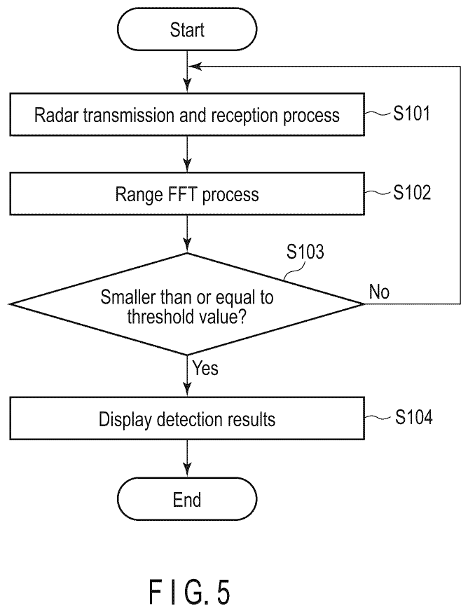

FIG. 5 is a flowchart showing an example of a processing flow of the detection system 100 according to the first embodiment.

First, radar transmission and reception is executed between the first radar 11 and the second radar 12 under the control of the synchronization unit 13 (S101). For example, the radar transmission and reception in S101 is executed sequentially at predetermined intervals, for all patterns of the combination of two radars 51 among the plurality of radars 51 or twice that number (in a case of executing the radar transmission and reception by replacing the transmitting and receiving sides with each other).

The data processing unit 14 executes the FFT processing on the radar information acquired by the second radar unit 12 (S102). Next, the line-of-sight determination unit 15 observes the signal power corresponding to the distance between the target radars (half the distance between the radars), based on the radar information after the range FFT processing (S103). If the power value is smaller than or equal to the threshold value (S103: Yes), the line-of-sight determination unit 15 determines that the state is the NLOS state and specifies the target located between the radars.

The detection results of the detection device 1 are supplied to the display device 2, and the display device 2 displays the detection results of the detection device 1 (S104). In the first embodiment, the display device 2 displays, for example, the position of the detection target.

In the conventional method, the position of the target object has been specified by analyzing the CIR obtained from both the line-of-sight signal and the reflected signal of the target object using processing with a comparatively large amount of calculation. In addition, the LOS/NLOS change has not been determined and the information has not been used for estimation of the target position.

In contrast, under the conditions that a plurality of radars operating in cooperation exist, in order to acquire the radar signal reflection characteristics of the target existing within a certain range, the detection device 1 of the first embodiment determines LOS if the signal strength of the line of sight between the radars is larger than or equal to the threshold value, or determines NLOS if the signal strength of the line of sight is smaller than or equal to the threshold value. Then, in the case of NLOS, the detection device 1 can detect that the target is located between the radars. In other words, the detection device 1 can specify the position of the target.

In addition, since information to be used in a target object classification process (more specifically, the arrival direction estimation process of the preprocessing) in a second embodiment to be described below is used as the radar information after the range FFT processing by the data processing unit 14, the data processing for LOS/NLOS detection as executed by the line-of-sight determination unit 15 can be executed without particularly increasing the quantity of data processing.

As described above, the detection device 1 of the first embodiment can realize specifying the position of the target, by determining whether or not the signal strength is smaller than or equal to the threshold value. In other words, the detection device 1 of the first embodiment can reduce the amount of calculation required to specify the position of the target.

### Second Embodiment

Next, a second embodiment will be described.

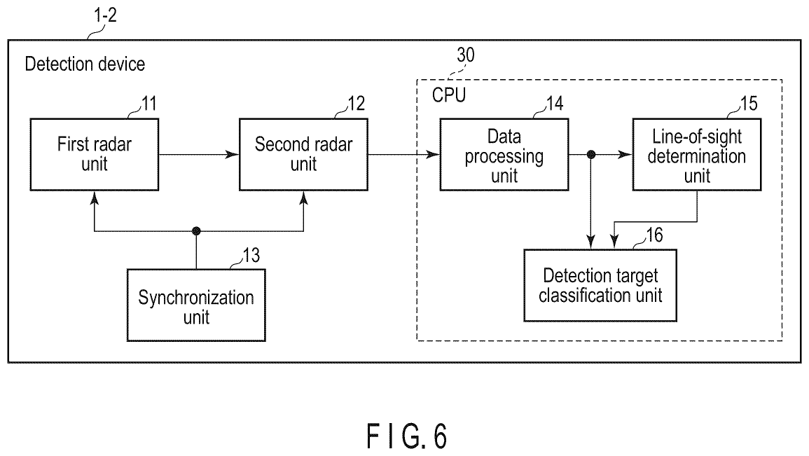

FIG. 6 is a view showing an example of a configuration of a detection device 1-2 according to the second embodiment.

The detection device 1-2 of the second embodiment further comprises a detection target classification unit 16 as compared to the detection device 1 of the first embodiment. For example, the detection target classification unit 16 is realized by the CPU 30 running a program. Alternatively, the detection target classification unit 16 may be realized by hardware such as an electric circuit.

The radar information used in the LOS/NLOS detection processing by the line-of-sight determination unit 15, as described in the first embodiment, is data that is also used in general radar data processing (for example, arrival direction estimation process), and is not additional data that is generated only for the purpose of executing the LOS/NLOS detection processing. Furthermore, the position of the target is limited to some extent by recognizing that the target exists between the radars by the LOS/NLOS detection processing. Therefore, for example, the area to be focused can be limited when executing the target object classification process based on the results of the arrival direction estimation process.

The detection target classification unit 16 receives the results of the arrival direction estimation process from the data processing unit 14 and receives the results of the LOS/NLOS detection process from the line-of-sight determination unit 15, and executes the target object classification process to specify the type of the detection target while limiting the area to be focused.

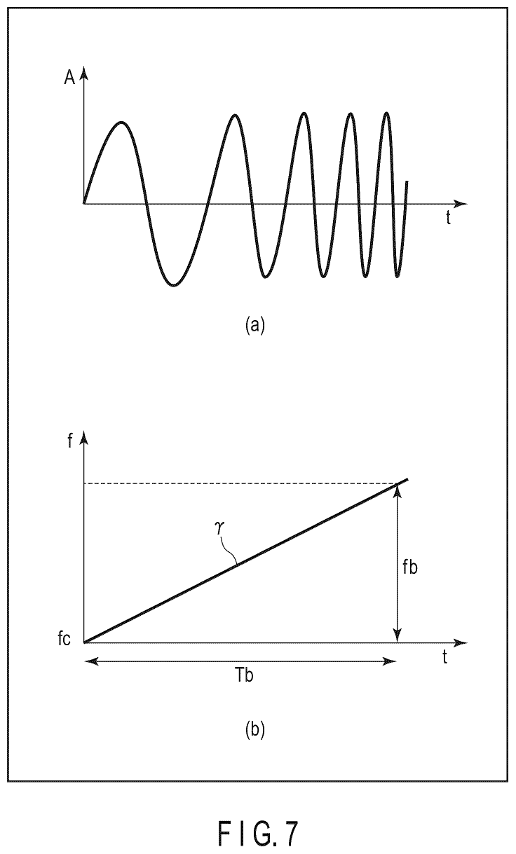

An example of the target object classification process executed by the detection target classification unit 16 will be described with reference to FIG. 7 to FIG. 9.

FIG. 7 is a view showing an example of a waveform of an FMCW signal used in the detection device 1-2. The FMCW signal is also referred to as a chirp signal.

The chirp signal is expressed as a function of amplitude A and time t, as shown in FIG. 7(a). In addition, the chirp signal is expressed as a function of frequency f and time t, as shown in FIG. 7(b). As shown in FIG. 7(b), the chirp signal is expressed by center frequency fc, modulation bandwidth fb, and signal time width Tb. A slope of the chirp signal is referred to as frequency change rate (chirp rate) γ.

A transmission wave St(t) of the FMCW signal transmitted by the first radar unit 11 is expressed by Formula 1.

$$St ( t ) = cos [ 2 π ( fct + γ {t}^{2} / 2 ) ] \qquad Formula 1$$

The chirp rate γ is expressed by Formula 2.

$$γ = fb / Tb \qquad Formula 2$$

In this case, the reflected wave from an object that is separated from the first radar unit 11 in a distance R is observed with a delay of Δt=2R/c from the transmission timing. c is the speed of light. The received signal Sr(t) is expressed by Formula 3 where the reflection intensity of the object is represented by a.

$$Sr ( t ) = a cos [ 2 π fc ( t - Δ t ) + {πγ ( t - Δ t )}^{2} ] \qquad Formula 3$$

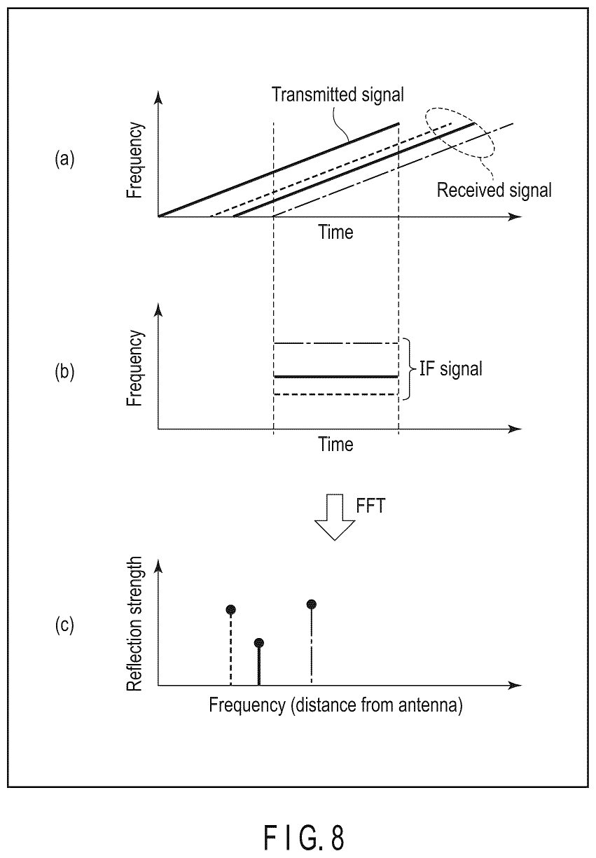

FIG. 8 is a view showing an example of received signals in a case where a plurality of, for example, three objects exist.

FIG. 8(a) shows a relationship between the transmitted signal/received signal and the time. As shown in FIG. 8(a), the frequency of the transmitted signal changes linearly with the time. The received signal is delayed by Δt with respect to the transmitted signal. When a plurality of objects exist, the reflected wave from the nearest object is received first as indicated by the broken line, and the reflected wave from the farthest object is received last as indicated by the one-dot chain line.

The received signal is multiplied by the transmitted signal in the data processing unit 14, and then the frequency components higher than the cutoff frequency are downconverted. The signal obtained in this manner is referred to as IF signal z(t) and is expressed by Formula 4.

$$z ( t ) = a cos ( 2 πΔ t γ t ) \qquad Formula 4$$

FIG. 8(b) shows a relationship between the frequency and the time of the IF signal. In an ideal environment with no noise or the like, the frequency becomes constant for each reflected wave. In this example, the frequency of the reflected wave from the nearest object is the lowest as indicated by the broken line, and the frequency of the reflected wave from the farthest object is the highest as indicated by the one-dot chain line.

The reflection intensity of the frequency

domain can be calculated by executing FFT of IF signal z(t) in the time domain shown in Formula 4 in the data processing unit 14. Therefore, the amplitude at each point in the frequency domain, which is the result of FFT of the IF signal, corresponds to the reflection strength at each distance from the radar. The frequency and the distance from the radar have a relationship of Formula 5.

$${f}_{if} = Δ t γ = 2 R γ / c \qquad Formula 5$$

If the distance to the person is n meters, the reflection strength of frequency f_{if} can be extracted from among the reflection strengths of a large number of received signals, as the reflection strength of the object, as shown in FIG. 8(c), by obtaining the frequency f_{if} of the IF signal corresponding to the point with a distance R=n meters from Formula 5.

The reflection strength can also be expressed as a heat map indicating a relationship between the angle of reception of the radar and the distance from the radar by executing the general radar process, i.e., the arrival direction estimation process. In the heat map, the information on the object can be obtained by, for example, observing the change in reflection strength along the distance direction (scanning direction).

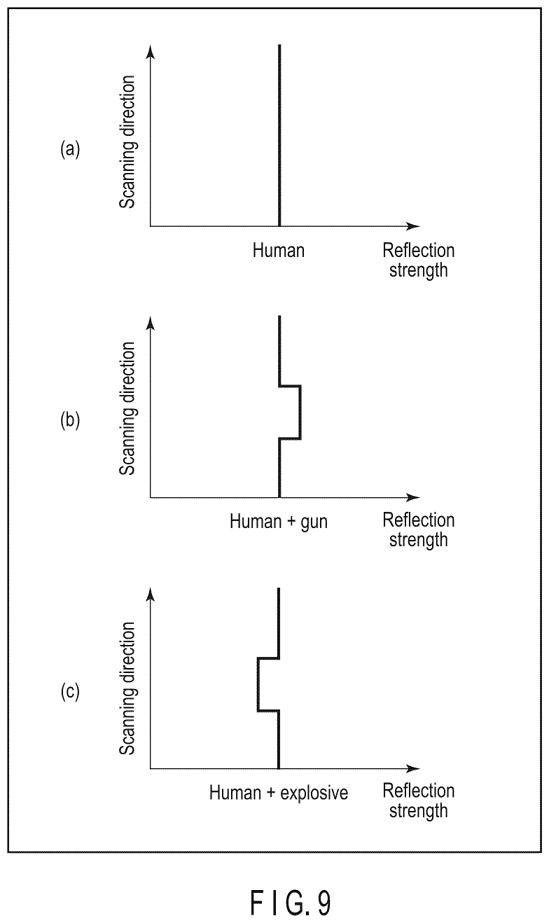

FIG. 9 is a view showing an example of the reflection intensity distribution obtained by the detection device 1-2.

The distribution of reflection intensity of radio waves on the scanning line is different depending on the material that reflects the radio waves, as shown in FIG. 9.

FIG. 9(a) shows the reflection intensity distribution in a case where a person does not hold anything. In this case, since the radio waves are reflected on person's skin, the reflection intensity of the radio waves does not change, and the distribution of the reflection intensity is flat. The reflection intensity distribution in FIG. 9(a) is the standard reflection intensity distribution corresponding to the standard inspection results.

FIG. 9(b) shows the radio wave reflection intensity distribution in a case where a person is holding a gun (metal) in the center of the scanning direction. In this case, since the metal has a higher reflection intensity as compared to skin, the radio wave reflection intensity is higher. Since the horizontal axis indicates the reflection strength (i.e., the reflection strength is higher on the right side), the reflection strength of the radio waves is distributed to be convex to the right side.

FIG. 9(c) shows the radio wave reflection intensity distribution in a case where a person is holding explosives in the center of the scanning direction. Since explosives absorb radio waves better than skin, the reflection strength of the radio waves is lower, such that the reflection strength of the radio waves is distributed to be convex to the left side.

Thus, the detection target classification unit 16 can specify the type of the detection target by obtaining the shape of the reflection strength distribution from the reflection strengths acquired at a plurality of points on the scanning line.

Incidentally, the shape of the reflection strength distribution can be obtained by executing the general radar data process, i.e., the arrival direction estimation process using the data used for determination of LOS/NLOS as it is and expressing the process as a heat map. In other words, complicated processes other than the general radar data process are unnecessary for the determination of LOS/NLOS.

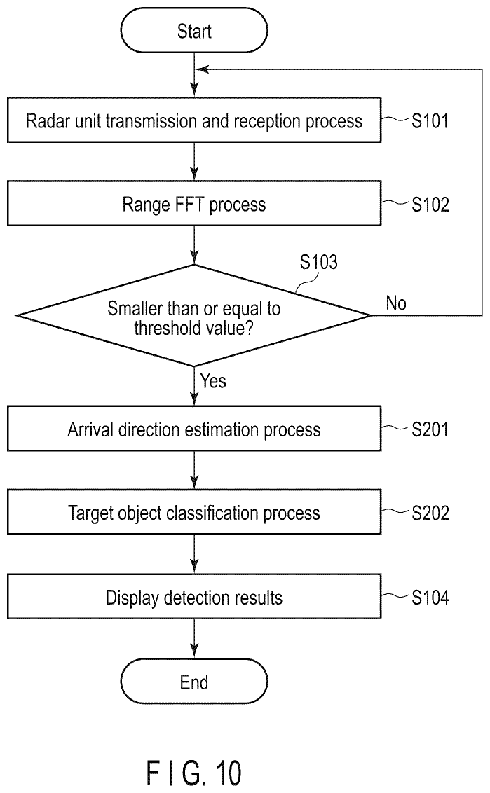

FIG. 10 is a flowchart showing an example of the processing flow of the detection system 100 according to the second embodiment.

Steps S101 to S103 are the same as those in the first embodiment. In the second embodiment, if the power value is smaller than or equal to the threshold value in S103 (S103: Yes), the data processing unit 14 executes the arrival direction estimation process (S201). Next, the detection target classification unit 16 executes the target object classification process using the results of the arrival direction estimation process to specify the type of the detected object (S202).

Similarly to the first embodiment, the detection results of the detection device 1-2 are supplied to the display device 2, and the display device 2 displays the detection results of the detection device 1 (S104). For example, the display device 2 of the second embodiment can display the type of the detection target in addition to the position of the detection target.

As described above, in the detection device 1-2 of the second embodiment, the target range of the arrival direction estimation process can be limited based on the LOS/NLOS detection process executed by the line-of-sight determination unit 15 and, furthermore, the processes can be simplified by limiting the area to be focused during the target object classification process. Alternatively, in a case where the detection result of LOS/NLOS detection is LOS, since it can be understood that no target exists at the position between the radars, the radar data processes in the range do not need to be executed and, in this respect, the detection device 1-2 of the second embodiment can also reduce the amount of data processing and the processing time. Thus, the detection device 1-2 of the second embodiment can use the information used for the LOS/NLOS determination as it is in the detection target classification process, and can eliminate unnecessary processing. Accordingly, the display device 2 connected to the detection device 1-2 of the second embodiment can further display the type of detection target.

### Third Embodiment

Next, a third embodiment will be described.

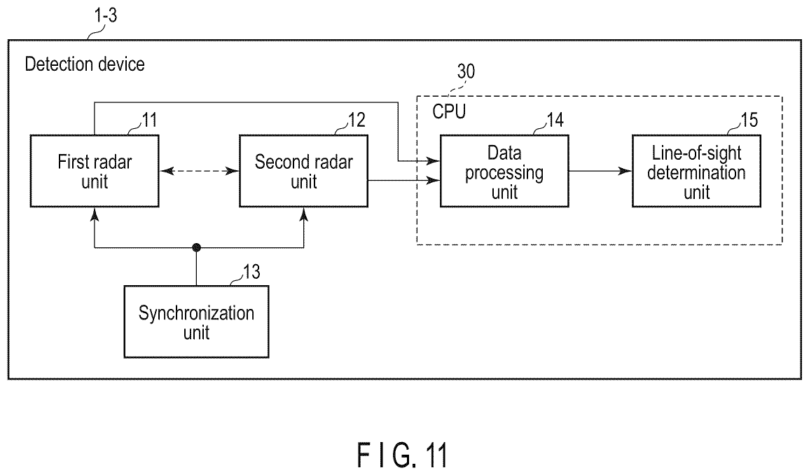

FIG. 11 is a view showing a configuration example of a detection device 1-3 according to the third embodiment.

In the first and second embodiments, the first radar unit 11 executes the signal transmission operation and the second radar unit 12 executes the signal reception operation. In contrast, in the detection device 1-3 of the third embodiment, each of the first radar unit 11 and the second radar unit 12 executes both the transmission operation and the reception operation. In FIG. 11, a double-ended arrow of a dashed line between the first radar unit 11 and the second radar unit 12 represents a flow of a bidirectional radar signal.

In other words, in the detection device 1-3 of the third embodiment, the first radar unit 11 transmits radar signals and acquires radar information with the second radar unit 12, and the second radar unit 12 transmits radar signals and acquires radar information with the first radar unit 11.

Then, in the detection device 1-3 of the third embodiment, the data processing unit 14 processes not only the output from the second radar unit 12, but also the output from the first radar unit 11. More specifically, the data processing unit 14 further executes the range FFT processing for the radar information acquired by the first radar unit 11. In addition, the line-of-sight determination unit 15 receives each signal strength from the data processing unit 14, and executes the LOS/NLOS detection process in both directions.

As a result, the detection device 1-3 of the third embodiment can improve the detection accuracy as compared to the first embodiment and the second embodiment.

### Fourth Embodiment

Next, a fourth embodiment will be described.

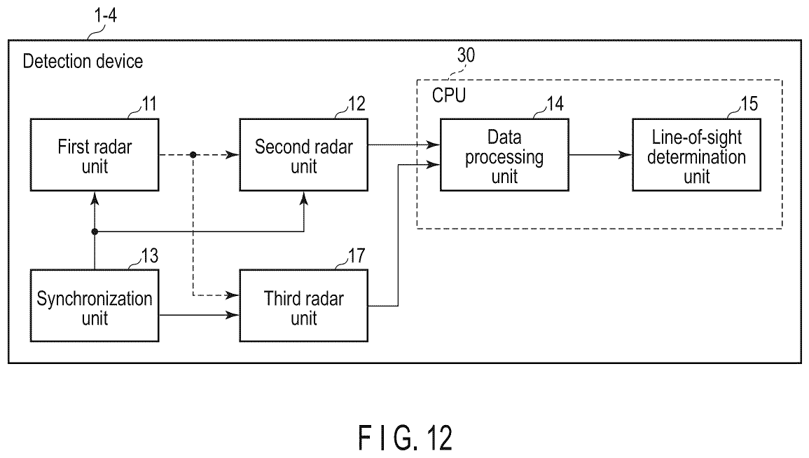

FIG. 12 is a view showing an example of a configuration of a detection device 1-4 according to the fourth embodiment.

As shown in FIG. 12, the detection device 1-4 of the fourth embodiment comprises a third radar unit 17 in addition to the first radar unit 11 and second radar unit 12. The third radar unit 17 is also connected to the synchronization unit 13, and synchronously makes a cooperative operation between all radars (first radar unit 11, second radar unit 12, and third radar unit 17).

More specifically, the synchronization unit 13 of the third embodiment notifies the first radar unit 11 of the timing to transmit the radar signals, and notifies the second radar unit 12 and the third radar unit 17 of the timing to acquire the radar information.

Then, in the detection device 1-4 of the fourth embodiment, the data processing unit 14 processes not only the output from the second radar unit 12, but also the output from the third radar unit 17. More specifically, the data processing unit 14 further executes range FFT processing on the radar information acquired by the third radar unit 17. In addition, the line-of-sight determination unit 15 receives each signal strength from the data processing unit 14, and executes the LOS/NLOS detection process at two points between the first radar unit 11 and the second radar unit 12 and between the first radar unit 11 and the third radar unit 17.

Thus, the detection device 1-4 of the fourth embodiment can execute LOS/NLOS detection at two points simultaneously.

In addition, in the detection device 1-4 of the fourth embodiment, for example, when the above-described process of specifying the type of the target object is executed in association with the detection of the existence of the target object, the target object is limited to the area in which NLOS is detected at one of the two points. As a result, the amount of data processing and the processing time can be reduced in the detection device 1-4 of the fourth embodiment as well.

Incidentally, the example of adding the third radar unit 17 as the radar which acquires the radar information has been described. However, the embodiment is not limited to this, and it is possible to add two or more radars and simultaneously execute the LOS/NLOS detection at three or more points.

### Fifth Embodiment

Next, a fifth embodiment will be described.

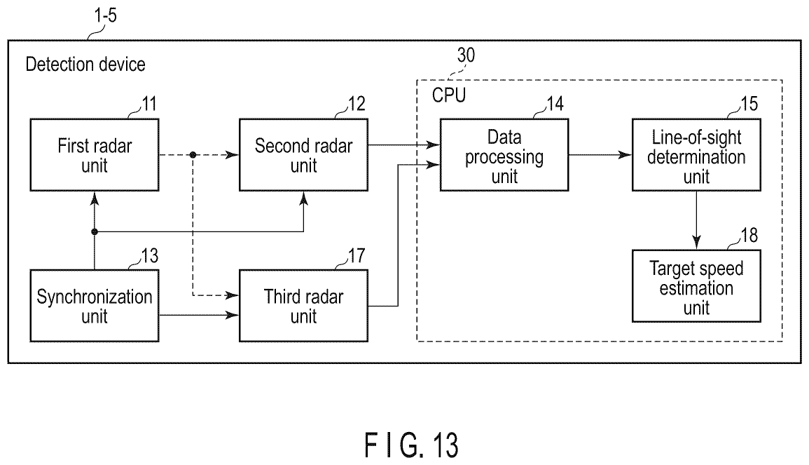

FIG. 13 is a view showing an example of a configuration of a detection device 1-5 according to the fifth embodiment.

A detection device 1-5 of the fifth embodiment further comprises a target speed estimation unit 18 as compared to the detection device 1-4 of the fourth embodiment. For example, the target speed estimation unit 18 is realized by the CPU 30 running a program. Alternatively, the target speed estimation unit 18 may be realized by hardware such as an electric circuit.

The target speed estimation unit 18 estimates the speed of the detection target 53 by using the LOS/NLOS detection results at two points from the line-of-sight determination unit 15. When it is assumed that the detection target 53 is moving at a substantially constant speed, the target speed estimation unit 18 can estimate the approximate speed of the detection target 53 from the time interval at which the two points change to NLOS.

Thus, the detection device 1-5 of the fifth embodiment can estimate not only an approximate position of the detection target 53, but also the speed of the detection target 53. Accordingly, the display device 2 connected to the detection device 1-5 of the fifth embodiment can further display the speed of the detection target 53.

### Sixth Embodiment

Next, a sixth embodiment will be described.

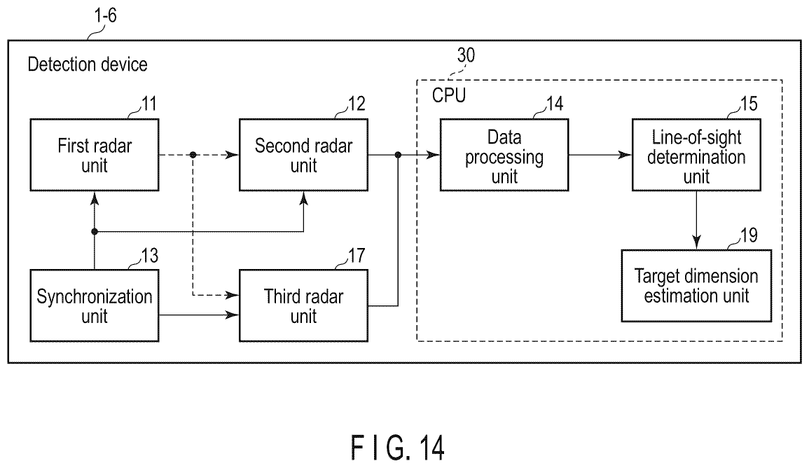

FIG. 14 is a view showing an example of a configuration of a detection device 1-5 according to the sixth embodiment.

A detection device 1-6 of the sixth embodiment further comprises a target dimension estimation unit 19 as compared to the detection device 1-4 of the fourth embodiment. For example, the target dimension estimation unit 19 is realized by the CPU 30 running a program. Alternatively, the target dimension estimation unit 19 may be realized by hardware such as an electric circuit.

The target dimension estimation unit 19 estimates the dimensions of the detection target 53 by using the LOS/NLOS detection results at two points from the line-of-sight determination unit 15. After NLOS detection at the first point, if the NLO detection of the second point occurs without interruption in the NLOS detection at the first point, the target size estimation unit 19 can estimate the size of the detection target 53 to be at least longer than or equal to the distance between the first location and the second location.

Thus, the detection device 1-6 of the sixth embodiment can estimate not only an approximate position of the detection target 53, but also the dimensions of the detection target 53. Accordingly, the display device 2 connected to the detection device 1-6 of the sixth embodiment can further display the dimensions of the detection target 53.

Incidentally, the examples that the method of each of the above-described embodiments regards the detection target as a human and is utilized to determine, for example, whether the human target holds a hazardous material has been described. The embodiments are not limited to this, and the fifth embodiment and the method described in the fifth embodiment can also be used to estimate the speed and dimensions of train cars, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A detection device comprising:
a first radar unit configured to transmit a radar signal;
a second radar unit configured to receive a radar signal;
a data processing unit configured to process radar information acquired by the second radar unit and output a first value and a first distance, the first value being indicative of a relationship between a signal strength, the first distance being determined by a distance between the first radar unit and the second radar unit; and
a determination unit configured to determine, when the first value output from the data processing unit is smaller than or equal to a threshold value, that a target object exists at a position between the first radar unit and the second radar unit.

2. The detection device of claim 1, further comprising a synchronization unit configured to make a cooperative operation of the first radar unit and the second radar unit.

3. The detection device of claim 1, further comprising a detection target classification unit configured to specify a type of the target object based on the first value which is used in the determination unit and which is output from the data processing unit.

4. The detection device of claim 1, wherein
the first radar unit and the second radar unit are frequency modulated continuous wave (FMCW) radars, and
the data processing unit is configured to acquire FTT data by executing fast Fourier transform (FFT) on the radar information, and output the FTT data as the first value.

5. The detection device of claim 1, wherein
the first distance is a distance which is half the distance between the first radar unit and the second radar unit.

6. The detection device of claim 1, wherein
the second radar unit is capable of transmitting a radar signal,
the first radar unit is capable of receiving a radar signal, and
the data processing unit is capable of processing the radar information acquired by the first radar unit and outputting a second value indicating a relationship between the first distance and a signal strength.

7. The detection device of claim 1, further comprising a third radar unit configured to receive a radar signal, wherein
the data processing unit is further configured to process radar information acquired by the third radar unit and output a third value and a second distance, the third value being indicative of a relationship between a signal strength, the second distance being determined by a distance between the first radar unit and the third radar unit, and
the determination unit is further configured to determine, when the third value output from the data processing unit is smaller than or equal to a threshold value, that a target object exists at a position between the first radar unit and the third radar unit.

8. The detection device of claim 7, further comprising a detection target classification unit configured to specify a type of the target object based on the first value or the third value which is used in the determination unit and which is output from the data processing unit, wherein
the detection target classification unit is further configured to
execute, when it is determined that the target object exists at the position between the first radar unit and the second radar unit, specifying the type of the target object using only the first value among the first value and the third value, and
execute, when it is determined that the target object exists at the position between the first radar unit and the third radar unit, specifying the type of the target object using only the third value among the first value and the third value.

9. The detection device of claim 7, further comprising a speed estimation unit configured to estimate a speed of the target object, based on a difference between a time when it is determined that the target object exists at the position between the first radar unit and the second radar unit and a time when it is determined that the target object exists at the position between the first radar unit and the third radar unit, the position between the first radar unit and the second radar unit, and the position between the first radar unit and the third radar unit.

10. The detection device of claim 7, further comprising a dimension estimation unit configured to estimate, when it is continuously determined that the target object exists between the first radar unit and the second radar unit and when it is determined that the target object exists at the position between the first radar unit and the third radar unit, a dimension of the target object to be larger than or equal to a distance from the position between the first radar unit and the second radar unit to the position between the first radar unit and the third radar unit.

11. A detection system comprising:
the detection device of claim 1; and
a display device, wherein
the display device is configured to display a position of the target object detected by the detection device.

12. A detection system comprising:
the detection device of claim 7; and
a display device, wherein
the display device is configured to display a position of the target object detected by the detection device and a type of the target object specified by the detection device.

13. A detection system comprising:
the detection device of claim 9; and
a display device, wherein
the display device is configured to display a position of the target object detected by the detection device and a speed of the target object estimated by the detection device.

14. A detection system comprising:
the detection device of claim 10; and
a display device, wherein
the display device is configured to display a position of the target object detected by the detection device and dimensions of the target object estimated by the detection device.

15. A non-transitory computer-readable storage medium having stored thereon a computer program which is executable by a computer, the computer program controlling the computer to execute functions of:
transmitting a radar signal by a first radar unit;
receiving a radar signal by a second radar unit;
processing radar information acquired by the second radar unit and acquire a first value and a first distance, the first value being indicative of a relationship between a signal strength, the first distance being determined by a distance between the first radar unit and the second radar unit; and
determining that a target object exists at a position between the first radar unit and the second radar unit when the first value is smaller than or equal to a threshold value.
